(19) United States
(12) Patent Application Publication
(10) Pub. No.: US 2005/0283352 A1
(43) Pub. Date: Dec. 22, 2005

(54) Evaluation of process expressions on the basis of deployment information

(76) Inventors: Dieter Roller, Schoenaich (DE); Frank Leymann, Aidlingen (DE)

Correspondence Address: IBM CORPORATION;INTELLECTUAL PROPERTY LAW, 11400 BURNET ROAD, AUSTIN, TX, 78758, US

(21) Appl. No.: 11/133,428

(22) Filed: May 19, 2005

(30) Foreign Application Priority Data
Jun. 18, 2004 (EP) 04102796.2

(51) Int. Cl. G06F 9/45

(52) U.S. Cl. 703/22

(57) ABSTRACT

The invention provides a method, a data processing system and a computer program product for evaluating an expression of a process model. The process model has at least one activity that is adapted to invoke at least one port type provided by a web service. The inventive method comprises the steps of: receiving of deployment variables stored by means of a deployment descriptor, evaluating the expression on the basis of the deployment variables.

### FIELD OF THE INVENTION

The present invention relates to the field of workflow management systems (WFMS) making use of web services or other network accessible services.

### BACKGROUND AND PRIOR ART

A new area of technology with increasing importance is the domain of workflow management systems (WFMS). WFMS support the modeling and execution of business processes. Business processes executed within a WFMS environment control who will perform which piece of work of a network of pieces of work and which resources are exploited for this work. The individual pieces of work might be distributed across a multitude of different computer systems connected by some type of network.

All services that are offered on the Internet or even within a company are described as Web Services. Web Services provide a basis for business-to-business applications and in particular for e-sourcing. e-sourcing provides the capability of users to decide whether to run their own computer systems, own applications or own business processes or to lease them from e-utilities or Application Service Providers. In principle, a Web Service can range from a simple service, such as the checking of a credit card number up to very complex services, such as the loan for a car. Simple services are typically implemented as executables such as e.g. Enterprise Java Beans (EJB). More complex services are typically constructed as business processes made up of a whole set of simpler services.

The requestor of a particular Web Service must be provided with appropriate information of the Web Service; this includes a general description of a Web Service and further Web Service related information of how to locate and how to invoke the Web Service. Preferably, the general description of the Web Service provides important details like payment information as well as cancellation policies that may apply.

Web Services are described using the “Web Services Description Language (WSDL)”. For more information on this language refer to W3C, Web Services Definition Language (WSDL) 1.1, http://www.w3.org/TR/wsd.html. WSDL defines three major pieces that describe a particular Web service.

First, WSDL defines the interface of the Web Service using the notion of a “port type” that is associated with a set of “operations” and their related input and output messages. This provides for the exact definition of the interface of a Web Service.

Second, WSDL defines the endpoint that delivers the functions described via the port type and its operation. This is done using the notion of a port. In its simplest form this is an address in the Internet, for example www.ourCompany.com.

Third, WSDL defines the protocols and bindings that a particular port supports and that the requester must use to obtain the appropriate service.

If a requester wants to use a particular Web service that implements a particular port type, it would access the WSDL definition to determine the port and the binding and protocol information. A more flexible approach is provided by Web Service Addressing that provides for the direct specification of an endpoint in the form of an endpoint reference. Fur further information refer to BEA Systems, IBM Corporation, Microsoft Corporation. Web Services Addressing (http://www.ibm.com/developerworks/library/ws-add).

An endpoint reference is an object that carries all the information needed to access the service. The information can be everything from a simple reference to a WSDL file holding the port and binding information to the inline definition of address and binding information, possibly also information that describes the policies associated with the endpoint.

The characteristics and capabilities of a Web service are typically described by decorating the Web service with policy statements using the Web Service Policy Framework (WS-Policy) (see also BEA Systems, IBM Corporation, Microsoft Corporation, SAP AG. Web Services Policy Framework (WS-Policy). http://www.ibm.com/developerworks/webservices/library/ws-polfram), Web Services Policy Attachment (WSPolicyAttachment), Web Services Policy Assertion Language (WS-Policy Assertions).

The structure of business processes is typically described using the “Business Process Execution Language for Web Services (BPEL4WS)”specification. For detailed information on BPEL4WS refer to BEA Systems, IBM Corporation, Microsoft Corporation., SAP AG, Siebel Systems. Business Process Execution Language for Web Services. (http://www.ibm.com/developerworks/webservices/library/ws-bpel).

The overall purpose of the language is to orchestrate the interactions between a company (the process) and a set of partners. Partners can be everything from an external partner to an internal application. Each relationship between a company and a partner is defined in BPEL4WS as a “partner link”. A partner link is an instance of a partner link type. Each partner in such a partner link type plays a role; each role requires that a set of Web services is supported. If several partners in a business process have the same relationship (for example the process has several suppliers) with the process, one defines several partner links, one for each partner. It is also possible, that a business process interacts with several partners using the same partner link type but in different roles; this requires that one specifies for each partner link which role the process plays (“myRole”) and which role the partner plays (“partnerRole”). The partner link types used in BPEL4WS are defined as extensions to WSDL.

A business process is made up of a set of activities, each of which belonging to a particular type of activities. The most important types of activities are those that interact with a partner. Such activities are for example the “invoke”-activity for invoking a Web Service that is provided by a partner or the “receive”-activity for accepting a request or response from a partner.

The latter refers a situation where a partner invokes a Web Service provided by a business process. Each invoke and receive activity, or more precisely each instance of an invoke or receive type activity, references an appropriate partner link, the port type, that is being used, as well as the appropriate operation.

The basic structuring of a business process is achieved through the “sequence” and “flow” activity. The sequence activity causes the enclosed activities to be carried out in sequence while the flow activity causes the enclosed activities to be executed in parallel.

In the parallel execution mode, the sequence in which the enclosed activities are carried out can be further constrained by links. Links describe a potential sequence of execution of the activities. In graphical representations of a process model, links are typically represented as arrows interconnecting activities of the process model. The head of an arrow describes the direction in which the flow of control can move through the process.

The activity where a ink starts is called the source activity and the activity where a link ends is called the target activity. Obviously an activity can be source and target activity for different links. Activities that have no incoming link are called start activities and activities that have no outgoing link are denoted as end activities. In principle, an activity can be start activity as well as end activity. An activity that has multiple outgoing links is called a fork activity and an activity with multiple incoming links a join activity.

Each link of a process model is associated with a transition condition that is represented as a Boolean expression. When a business process is being carried out, this transition condition is evaluated after execution of the source activity has been completed. When the transition condition evaluates to true for a particular link, navigation follows this link to an appropriate target activity. If the transition condition evaluates to false, this particular link is not followed.

The BPEL4WS language provides another approach based on a so-called switch activity. This approach is similar to the case statement found in most programming language. Selection of an appropriate activity is based on appropriate expressions that are similar to the expression used in transition conditions.

Furthermore, BPEL4WS provides a while activity that determines how often a particular set of activities has to be carried out. The number of iterations is determined through an appropriate expression.

All expressions, whether used in transition conditions, switch activities, or while activities are Boolean expressions. When evaluated these expressions yield a result of “true” or “false”. The body of the Boolean expression typically consists of a set of comparisons that are combined with the Boolean operators OR or AND, for example. The comparisons are usually constructed using a first operand, a comparison operator, and a second operand, where the comparison between the first and second operand is done by using a comparison operator. The first and second operand can be literals as well as the value of fields that are part of the process context. The process context is the sum of all variables that are maintained within the process.

BPELWS offers a set of functions to access the value of a field, such as getVariableData(fieldA), which returns the value of the field fielda. When evaluated, the comparison yields a value of true or false.

Applications in a Web Service environment typically consist of a process model and a set of port types that are invoked by the process activities. Applications with the shown structure are typically called workflow-based applications (refer to F. Leymann and D. Roller: Workflow-based Applications, IBM Systems Journal, 36(1), 1997). When an activity of the process model has to be carried out, additional information is needed to identify the ports that implement the different port types. This is the general purpose of a deployment descriptor. It defines for each port type the appropriate port; that means it defines the endpoint of an implementation of the appropriate port type. In its simplest form, it defines the address where the implementation of the port type can be found. In a more elaborate specification, the deployment descriptor may specify some complex algorithms from which the address can be derived.

When a process is executed, i.e. the individual activities of a process model are carried out; the information in the deployment descriptor is used to determine the appropriate endpoint that implements the specified port types. Hence, the deployment descriptor provides information that is necessary to be able to invoke a Web Service that implements a specified port type. In detail, when the process navigates to a particular activity, that needs to be invoked, it determines the port type associated with the activity, obtains the associated service endpoint (port and binding information) information from the deployment descriptor, and then invokes the specified operation on the Web Service using the information retrieved from the deployment descriptor.

In the prior art, the exclusive purpose of the deployment descriptor is to supply information required for execution of Web Services, i.e. providing location information of an endpoint, cost information, cancellation policy, etc. . . . This means that the deployment descriptor is exclusively descriptive of ports relating to a port type that provides an implementation of the port type.

### SUMMARY OF THE INVENTION

The present invention provides a method that significantly enhances the power of an expression of a process model. It does so by providing a method for obtaining deployment information stored by means of a deployment descriptor or derived from the stored information and evaluating the expression of the activity on the basis of the received deployment variables or derived information.

The invention provides universal access to deployment information and allows processing of deployment information for evaluating expressions and conditions within a business process. In this way, information stored in a deployment descriptor does no longer exclusively serve to specify and to describe associated ports of a Web Service for the purpose of properly invoking of a port, but is made available to a business process.

By making use of a variety of access functions added to BPEL4WS, deployment information stored in the deployment descriptor or information derived from the deployment descriptor is made available to a business process.

Information related to port types, in particular location information or further relevant endpoint information of a port, might be of major relevance for a business process that invokes the port types. Having access to this information during execution of a process model is therefore particularly advantageous for evaluating of expressions.

The deployment variables stored in the deployment descriptor are indicative of e.g. a value that can be used as value of a variable, a location or an address of a port, information relating to invocation parameters, cost information of the offered Web Service, cancellation policy that applies upon invoking of the Web Service, etc. . . . Hence, the deployment variables are indicative of all conceivable types of endpoint information.

According to a further preferred embodiment of the invention, the deployment variables are further indicative of a policy associated with the process model or parts of the process model. Hence, the deployment descriptor is no longer purely descriptive of Web Services and their ports but also provides information related to the process model that is executed by the Workflow Management System. The policy of the process model may, for example, specify various execution policies that can be applied during execution of a process model. For example, a process policy may specify that the entire process model has to be executed time-optimized. Another process policy may indicate that the process model has to be executed with respect to a cost-optimization criterion.

Storing a policy of a process model by making use of a deployment descriptor allows defining a policy outside the scope of the process model. This allows to universally defining a process policy for each activity of the process model by appropriately determining the corresponding policy variable within the deployment descriptor. Hence, the execution policy that governs execution of the at least one activity of the process model can be defined and modified by means of a single variable stored in the deployment descriptor and that is accessible to the Workflow Management system executing the associate process model.

According to a further preferred embodiment of the invention, execution of the process model dynamically accounts for changes of the deployment variables. Hence, the Workflow Management system is adapted to respond to changes that apply to any of the deployment variables during execution of the process model. When for example after successful execution of e.g. three activities of the process model, the variable of the deployment descriptor that is indicative of the process policy becomes subject to modification, execution of all remaining activities of the process model that have to be invoked subsequently become subject of the new process policy as defined by the deployment descriptor.

According to a further preferred embodiment of the invention, the expression to be evaluated on the basis of the deployment variables is part of a transition condition between a first and a second activity of the process model. Moreover, the expression may entirely represent a transition condition of the process model. Deployment information provided by the deployment variables can therefore be exploited to evaluate a Boolean expression of the process model. Consequently, the control flow of a process model may substantially change with respect to the deployment variables. Obviously, deployment variables that are indicative of the process policy have a major impact on the flow of control of the process model.

According to a further preferred embodiment of the invention, the expression to be evaluated on the basis of the deployment variables is part of a while activity of the process model. Moreover, the expression may entirely represent a while activity of the process model. Making use of the deployment variables during evaluation of a while activity is particularly advantageous when a relevant deployment variable becomes subject to modification during execution of the while activity. Let's assume that a while activity of the process model encloses an activity that invokes a particular port type. The while activity specifies the conditions how often the enclosed activity should be carried out. When now after the second invocation of that port type, i.e. invocation of an associated port, the execution policy or the price of the port changes, a corresponding modification of the associated deployment variable will be made. Since the deployment variable is accessible to the Workflow Management system, the changed deployment variable can be exploited in order to e.g. abort execution of the while activity, when for example the price of the port has become unacceptable.

According to a further preferred embodiment of the invention, the expression to be evaluated on the basis of the deployment variables is part of a switch activity of the process model. Moreover, the expression may entirely represent a switch activity. Typically, a switch activity has a plurality of different control links that point to a variety of different activities of the process model. Hence, the deployment information that is accessible to the Workflow Management system can effectively be exploited in order to determine a single control link of a plurality of control links that has to be followed. Hence, navigation of a process model can be manipulated and controlled by making use of deployment information that becomes availably at runtime of the process model.

According to a further preferred embodiment of the invention, deployment variables are adapted to be modified by the at least one activity of the process model in response to evaluation of the expression of the process model. Hence, deployment variables become fully accessible to an activity of the process model. In this way activities of the process model are no longer restricted to obtain deployment information by accessing the deployment descriptor but become also enabled to modify deployment variables stored by means of the deployment descriptor.

In another aspect the invention provides a data processing system that is adapted to evaluate an expression of a process model. The process model has at least one activity that is adapted to invoke at least one port type provided by a web service. The data processing system comprises means for receiving of deployment variables stored by means of a deployment descriptor and means for evaluating the expression on the basis of the deployment variables.

In still another aspect the invention provides a computer program product that is operable in order to evaluate an expression of a process model. The process model has at least one activity that is adapted to invoke at least one port type provided by a web service. The computer program product comprises computer program means that are adapted to receive deployment variables stored by means of a deployment descriptor and further comprises computer program means for evaluating the expression on the basis of the deployment variables.

### BRIEF DESCRIPTION OF THE DRAWINGS

In the following, preferred embodiments of the invention will be described in greater detail by making reference to the drawings in which:

FIG. 1 shows the structure of a workflow-based application consisting of a process model and associated web services,

FIG. 2 shows the effects of the deployment descriptor on the execution of a workflow-based application,

FIG. 3 shows the conceptual structure of a deployment descriptor,

FIG. 4 illustrates the access of a deployment descriptor variable within a transition condition,

FIG. 5 illustrates the access of an endpoint address specified in a deployment descriptor within a transition condition.

### DETAILED DESCRIPTION

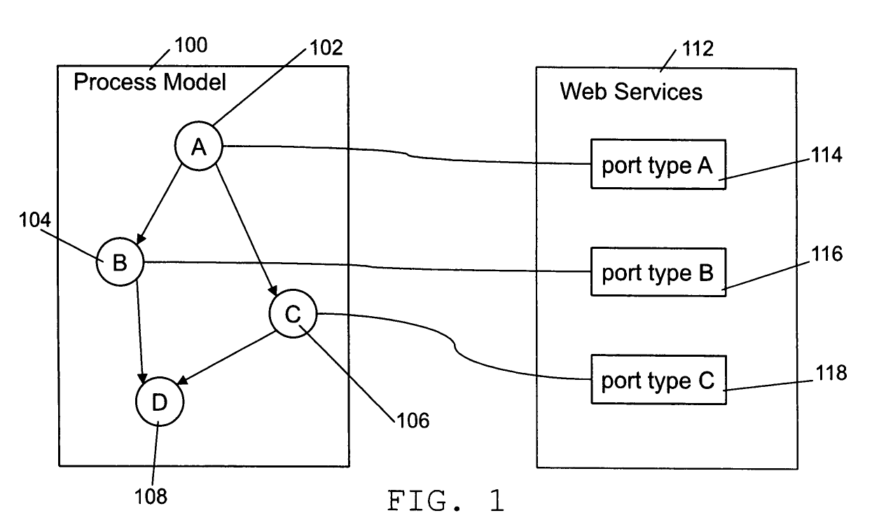

FIG. 1 is illustrative of the structure of workflow-based applications; they consist of a process model and a set of associated Web services. The process model 100 consists of a set of activities 102, 104, 106, 108; each of them designed to perform a particular task. Some of the activities are provided by a set of appropriate Web services 112; for example the task carried out in activity A 102 is supported by the Web service that implements port type A 114. Each individual Web service is defined as a set of WSL port types 114, 116, 118. If an activity invokes an appropriate Web service, it does so by invoking a specified method supplied by the port type. It should be noted that each port type is part of a partner link type, which itself is part of a partner link defined within the process. This requires that the activity also specifies partner link that is used for invoking the method on the specified port type.

When the business process is being carried out, the workflow management system needs to know the actual endpoints that deliver the capabilities specified via the port types 114, 116, 118. This information is provided as part of installing the application, a process typically called deployment.

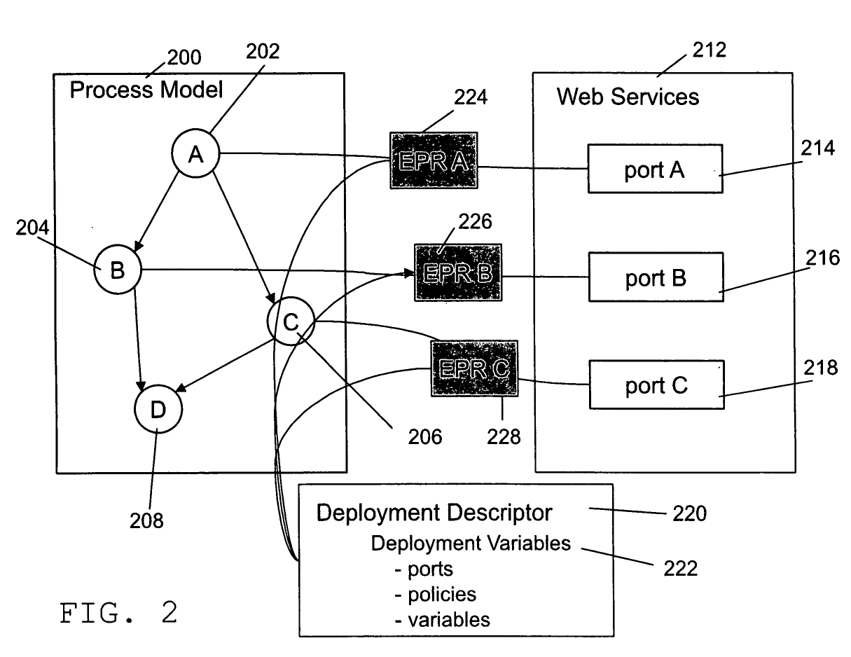

It is the purpose of the deployment descriptor 220 shown in FIG. 2 to provide this information; that means it defines in general for each partner link the port (including binding information) that implements the port type. In other words, each of these port types is bound to a port finally processing requests of the process activities 102, 104, 106, 108. When, for example as shown in FIG. 1, port type A 114 is invoked by activity A 102, the deployment descriptor defines the port A 216 that implements port type A 114 for activity A 102.

Definition of the port associated with a port type invoked by a particular activity can be as simple as pointing to a port within a WSDL definition, the specification of an address, or the specification of a complex expression that is evaluated when the activity needs to be carried out.

Deployment information for the various port types 114, 116, 118 as well as information about the process model 100 and the activities 102, 104, 106, 108 can be provided by a single deployment descriptor 220 or alternatively by a plurality of different deployment descriptors. In the latter case each of the plurality of deployment descriptors is then associated to one of the port types 114, 116, 118.

FIG. 2 further illustrates the interplay between the activities of a process model 200, a deployment descriptor 220 and the associated Web services provided as ports 214, 216, 218. It should be noted that the application shown in FIG. 2 is the deployed workflow-based application shown in FIG. 1.

When the workflow management navigates through a process it carries out the following actions for an activity that invokes a Web service:
determine if the activity is to be carried out and if not skip processing of the remaining actions;
determine the port for the port type associated with the activity by accessing the deployment descriptor;
invoke the Web service using the endpoint information.

It should be noted that the deployment descriptor conceptually returns an endpoint reference 224, 226, 228 that identifies the port and, as pointed out earlier, provides all the information of invoking the port, including address of the port, binding information, and policy information associated with the port.

The information in the deployment descriptor 220 is made up of a set of deployment variables 222. These deployment variables contain all the information to obtain all the properties of the port that implements a port type in a particular partner link. The information could be as simple as an address stored in literal form, the pointer to a policy statement associated with the port, up to a complex expression that returns an endpoint reference.

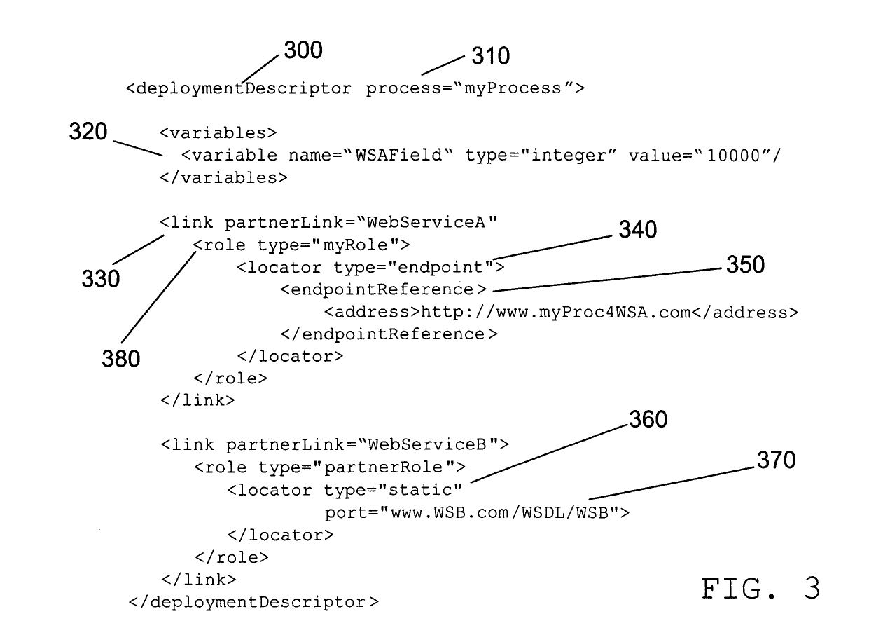

FIG. 3 shows the conceptual structure of a deployment descriptor. It is for illustration only and should not be construed as the only way of specifying a deployment descriptor. Any other form that describes the relationship between a port type used in a process and the actual endpoint in the spirit of the present application should be allowed.

An XML representation has been chosen to stay in the spirit of Web services standards that use XML as their definition language (in fact they use XML schema); that means the deployment descriptor is an XML document. The <deploymentDescriptor> 300 element is the root of the document; the attribute <process> 310 identifies the process to which this deployment descriptor applies to by providing the appropriate process name.

The <variables> element 320 identifies variables that can be used by the proposed present application for evaluation in expressions. Individual variables are defined by the <variable> element. The name attribute gives the variable a name; the type attribute an appropriate XML type.

The <link> element 330 provides information about the different partner links; that means it defines the endpoints that are to be used for invocation of a Web service or the endpoints that the business process exposes itself. The attribute partnerLink 330 identifies the partner link within the business for which endpoint information is provided. The <role> element 380 defines to which role of the partner link the endpoint definition should apply to. If type=“myRole” is specified, the enclosed <locator> element identifies the endpoint that the process provides for the partner link; if type=“partnerRole” is specified, the enclosed <locator> element identifies the endpoint that the partner provides. The <locator> element supports many different ways how the appropriate endpoint is specified; the value of the type attribute within the <locator> element provides the appropriate selection mechanism. The value “endpoint” 340 indicates that the endpoint is specified via an endpoint reference 350 expressed in WS-Addressing. In the example, the service is provided at the address http://www.myProc4WSA.com.

The value “static” 360 identifies that the endpoint is provided via the port definition within the WSDL located at http://www.WSB.com/WSDL/WSB. This is just a short list of possibilities that are conceivable for specifying endpoints for the Web services to be invoked.

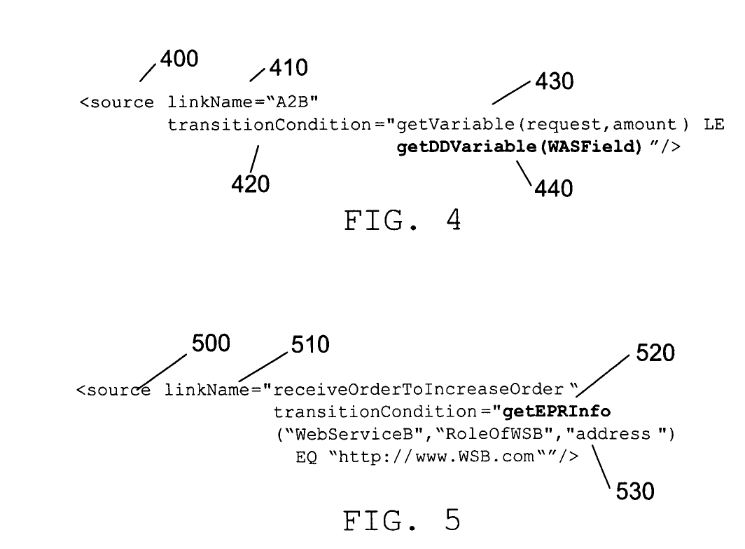

FIG. 4 through FIG. 5 show how the information provided by the deployment descriptor can be used in expressions through a set of functions to access properties of the deployment descriptor or information derived from the information in the deployment descriptor.

FIG. 4 shows the definition of a transition condition that accesses a variable defined in the deployment descriptor. The <source> element 400 is used to attach a link to an activity; the separately defined link is identified via the linkName attribute 410. The transition condition is identified via the transitionCondition attribute 420. The shown expression uses a standard getvariable function 430 of BPEL4WS to access the amount field in the request message. This is then compared (LE corresponds to less equal) with the value of the variable WSAField defined in FIG. 3. The value is obtained by using the function getDDVariable (get Deployment Descriptor variable) that is proposed for the present application. This approach of fetching the value from the deployment descriptor is significantly more flexible than the state-of-the-art approach of using a fixed value in the expression. With the proposed approach the value can be changed any time until the value is needed.

FIG. 5 illustrates how the address of a port could be accessed within a transition condition. The getEPRInfo function 520 is used to obtain the value of property of a port; it accepts three parameters and returns the appropriate value. The first parameter indicates the appropriate partner link 510; the second parameter specifies the role that the queried port plays in the partner link; the third parameter specifies the property whose value should be returned. In FIG. 5, the transition condition then evaluates to true, if the address 530 of the port playing the role of RoleOfWSB in the partner link WebServiceB has the address http://www.WSB.com.

FIG. 3 to 5 are just illustrative of the type of information is stored in a deployment descriptor and that can be accessed via appropriate functions. It is assumed that the proposed present application can be used to access any type of information from a deployment, regardless whether the deployment descriptor contains the information directly, the deployment descriptor references the information (such as policies), the information references the information in the deployment descriptor, or the information is derived by some means from the information in the deployment descriptor.

### LIST OF REFERENCE NUMERALS

100 Process Model
102 activity A
104 activity B
106 activity C
108 activity D
112 Web Services
114 Port Type A
116 Port Type B
118 Port Type C
200 Process Model
202 activity A
204 activity B
206 activity C
208 activity D
212 Web Services
214 Port A
216 Port B
218 Port C
220 Deployment Descriptor
222 Deployment Variables
224 Endpoint Reference A
226 Endpoint Reference B
228 Endpoint Reference C
300 Deployment Descriptor
310 Reference to Process
320 Variable Definition
330 Reference to partner link
340 Locator of type endpoint
350 Endpoint reference
360 Locator of type static
370 Reference to WSDL file
380 Reference to role in partner link
400 Source of link
410 Reference to link
420 Transition condition
430 Function to access process variable
440 Function to access variable in deployment descriptor
500 Source of link
510 Reference to link
520 Function to access endpoint information
530 Reference to property to be fetched

1. A method in a data processing system of evaluating an expression of a process model, the process model having at least one activity adapted to invoke at least one port type provided by a web service, the method comprising the steps of:
receiving of deployment variables stored by means of a deployment descriptor; and
evaluating the expression on the basis of the deployment variables.

2. The method according to claim 1, wherein the deployment variables are indicative of a policy of the process model.

3. The method according to claim 1, wherein execution of the process model dynamically accounts for changes of the deployment variables.

4. The method according to claim 1, wherein the expression is part of a transition condition between a first and a second activity of the process model.

5. The method according to claim 1, wherein the expression is part of a while activity of the process model.

6. The method according to claim 1, wherein the expression is part of a switch activity of the process model.

7. A data processing system adapted to evaluate an expression of a process model, the process model having at least one activity adapted to invoke at least one port type provided by a web service, the data processing system comprising:
means for receiving of deployment variables stored by means of a deployment descriptor; and
means for evaluating the expression on the basis of the deployment variables.

8. The system according to claim 7, wherein the deployment variables are indicative of a policy of the process model.

9. The system according to claim 7, wherein execution of the process model dynamically accounts for changes of the deployment variables.

10. The method according to claim 7, wherein the expression is part of a transition condition between a first and a second activity of the process model.

11. The method according to claim 7, wherein the expression is part of a while activity of the process model.

12. The method according to claim 7, wherein the expression is part of a switch activity of the process model.

13. A computer program product operable to evaluate an expression of a process model, the process model having at least one activity adapted to invoke at least one port type provided by a web service, the computer program product comprising:
means adapted to receive deployment variables stored by means of a deployment descriptor; and
means adapted to evaluate the expression on the basis of the deployment variables.

14. The computer program product according to claim 13, wherein the deployment variables are indicative of a policy of the process model.

15. The computer program product according to claim 13, wherein execution of the process model dynamically accounts for changes of the deployment variables.

16. The computer program product according to claim 13, wherein the expression is part of a transition condition between a first and a second activity of the process model.

17. The computer program product according to claim 13, wherein the expression is part of a while activity of the process model.

18. The computer program product according to claim 13, wherein the expression is part of a switch activity of the process model.
